(19) United States
(12) Patent Application Publication
(10) Pub. No.: US 2025/0052279 A1
(43) Pub. Date: Feb. 13, 2025

(54) ROLLER BEARING CAGE

(71) Applicant: AKTIEBOLAGET SKF, GOTEBORG (SE)

(72) Inventors: Hongbing QI, Dalian (CN); Dominik FRITZ, Würzburg (DE); Sabine HOFMANN, Kürnach (DE); Jinguang ZHU, Dalian (CN)

(21) Appl. No.: 18/780,929

(22) Filed: Jul. 23, 2024

(30) Foreign Application Priority Data
Aug. 8, 2023 (CN) 202310988835.1

(51) Int. Cl. F16C 33/46

(52) U.S. Cl. CPC F16C 33/4676; F16C 33/4682

(57) ABSTRACT

A bearing cage configured for a large-diameter roller bearing includes a first ring element, and a first bridge extending substantially axially from a first connection region of the first ring element. The first connection region includes a first recess extending into the first ring element that has a radially outer end and a radially inner end and a first radius of curvature at a location between the radially outer end and the radially inner end, and the first radius of curvature is constant or variable.

### CROSS-REFERENCE

This application claims priority to Chinese patent application no. 202310988835.1 filed on Aug. 8, 2023, the contents of which are fully incorporated herein by reference.

### TECHNOLOGICAL FIELD

The present disclosure is directed to a bearing cage for a roller bearing, in particular for a tapered roller bearing, and to a roller bearing, in particular a tapered roller bearing, including such a bearing cage.

### BACKGROUND

Bearing cages are usually used in roller bearings to support and guide the rolling elements of the roller bearing, preferably in a uniformly spaced manner. Such bearing cages can be manufactured from metal or plastic. The cage itself usually includes two ring elements axially offset from each other, which are connected to each other via bridges so that pockets are formed between the ring elements and bridges, in which pockets the rolling elements are received. However, this also means that the rolling elements received in the pockets and the elements of the cage that form the pockets interact with each other so that the bearing cage is subjected to heavy loads.

It has been found that particularly in the case of roller bearings in which the cages have a substantially angular shape, the structural loading of the cage in the corners, i.e., in the transition region between a bridge and a ring element, is particularly high. In order to reduce this load concentration in the corners of the pockets, it has been proposed to increase the radius of curvature in the corners of the pockets. However, with roller-shaped rolling elements this leads to interference with the edge reductions provided on the rollers so that the radius of curvature in the corners of the pockets cannot be increased arbitrarily. Furthermore, in applications that require a roller bearing having a large diameter, for example wind turbines, the loads acting on the bearing cage increase even further.

### SUMMARY

It is therefore an aspect of the present disclosure to provide a bearing cage of a rolling-element bearing, in particular for a tapered roller bearing, which bearing cage has a large structural load-bearing capacity.

In the following a bearing cage for use in a roller bearing, in particular a roller bearing having a large diameter, is provided. For example, a diameter of the outer ring may be larger than 1 meter. More particularly, the roller bearing may be a tapered roller bearing. For example, the roller bearing may be used in a wind turbine. The bearing cage comprises at least a first ring element extending in a circumferential direction of the bearing cage and at least one bridge extending substantially in an axial direction of the bearing cage. The at least one bridge is connected to the first ring element at a first connection region, and the first connection region has a recess that extends into the first ring element. More particularly, if the roller bearing is a tapered roller bearing, the first ring element may be the large diameter ring element.

Moreover, the at least one bridge may have a predetermined bridge width in the circumferential direction of the bearing cage, and the ring element may have a predetermined ring element thickness in the axial direction of the bearing cage. In particular, the recess may be formed such that the recess only extends into the first ring element. In other words, the recess may be formed so that it does not extend into the bridge. In addition, a width of the at least one bridge in the circumferential direction at a location in the first connection region may be greater than a width of the at least one bridge in the circumferential direction at a location axially spaced from the recess. That is, the width of the at least one bridge in the circumferential direction may increase in the first connection region. Also, the enlargement of the bridge width in the first connection region may be continuous and occur along a curvature having a radius.

In order to increase the structural load-bearing capacity of the bearing cage, the recess has a curvature having a predetermined radius. In particular, the structural weakening of a bearing cage that includes a recess on the bridge and ring element arises primarily due to the recess on the bridge. Therefore, by providing the recess primarily in the ring element, which may reduce the ring element thickness in the connection region between ring element and bridge, the bridge has an essentially consistent bridge width or even an increased width.

The predetermined radius may be constant along the curvature, or the radius of curvature may vary along the curvature. For example, if the radius of curvature varies along the curvature, the structural load-bearing capacity of the cage can be optimized by changing the radius of curvature such that the bearing cage is structurally stronger at locations that are subjected to a higher stress level. Due to the consistent bridge width or the increase of the bridge width the structural load-bearing capacity of the cage can be significantly increased, while at the same time a larger radius of curvature is possible in the transition between the bridge and the ring element. Nevertheless, due to the recess in the ring element an interference with the edge reduction of the roller to be held by the cage, or a jamming of the roller, can be avoided. In particular, the predetermined radius may be characterized by a starting point on the bridge, namely a location on the bridge at which the recess begins, and a resulting recess depth y in the axial direction. That is, a recess having a curvature with a constant radius r and a recess having a curvature with a radius r′ that varies along the curvature may have the same starting point on the bridge and the same recess depth but may differ with respect to a recess length x in the circumferential direction. Thus, by characterizing the predetermined radius by the starting point on the bridge, and the resulting recess depth y in the axial direction, it is possible to define, for each variable radius r′, an equivalent constant radius r.

Preferably, the radius of curvature varies such that the radius increases towards a zone of maximum stress and decreases outside of the zone of maximum stress. This allows to use an increased radius in the most stressed zone, which may lower the resulting stress on the bearing cage and a decreased radius outside this zone, which allows to limit a recess depth. For example, the radius of curvature may vary continuously along the curvature. Preferably, the radius of curvature may vary exponentially, logarithmically, linearly, and/or according to a polynomial of nth grade.

According to a further preferred embodiment, the bearing cage includes a second ring element, wherein the at least one bridge is connected to the second ring element at a second connection region, wherein a width of the bridge in the circumferential direction of the bearing cage at a location in the second connection region is smaller than a width of the at least one bridge in the circumferential direction of the bearing cage at a location in the first connection region and/or a width of the at least one cage in the circumferential direction of the bearing cage at a location that is axially spaced from the recess.

Here it is particularly advantageous if the recess on the ring element and the bridge widening in this region is provided not only on the first ring element of the bearing cage but also on the second ring element of the bearing cage, which is disposed axially offset with respect to the first ring element. As is known, the two ring elements are usually connected to the bridges and together with the bridges form pockets for receiving the rolling elements. Due to the design of the recess on both ring elements the structural load-bearing capacity of the cage can be further increased, and a jamming of the roller in the pocket can be avoided.

According to a further preferred embodiment, a pocket configured to receive a rolling element is defined between a first and second bridge and between the first and second ring elements, wherein a distance between the first and second bridge in the circumferential direction defines a pocket width, and a distance between the first and second ring element in the axial direction defines a pocket length, wherein a pocket width is minimal at a position which is spaced at 20 to 60% of the pocket length from the second ring element. This may provide a structure that allows the rolling element to be snapped into the pocket which may allow for a tilting of the rolling element during an assembly of the roller bearing and therefore for an easier assembly of the roller bearing, particularly if the roller bearing has a large diameter.

Preferably, the roller bearing is a tapered roller bearing in which the second ring element has a smaller diameter than the first ring element, wherein the minimal pocket width is located at a position which is spaced at 25-55% of the pocket length from the second ring element. In this case, it may be advantageous if the width of the bridge in the circumferential direction of the bearing cage at a location in the second connection region may be smaller than the width of the bridge in the circumferential direction of the bearing cage at a location in the first connection region and the width of the at least one cage in the circumferential direction of the bearing cage at a location that is axially spaced from the connection region. In other words, in case that the roller bearing is a tapered roller bearing, the width of the bridge in the circumferential direction of the bearing cage may be smallest in the connection region that connects the bridge to the smaller ring element of the bearing cage.

The bearing cage itself can be manufactured one-piece, for example, from a metal plate; however it is also possible that the bearing cage is formed from individual elements.

In addition, the recess on the first and/or second ring element may define a minimum ring element thickness Rₘᵢₙ, and the cage may have a maximum bridge width Sₘₐₓ at the location of the minimum ring element thickness Rₘᵢₙ. This means that the bridge in the direction of the minimum ring element thickness Rₘᵢₙ is preferably continuously widened so that structural weaknesses that could arise, for example due to the formation of the recess, are compensated by the increasing of the bridge width.

Furthermore, the recess may have a particular recess length x in the circumferential direction of the first and/or second ring element and a recess depth y in the axial direction, wherein a ratio of recess length x to recess depth y falls in the range of 2 to 10 (2≤(x/y)≤10). Such a ratio may allow for an optimal guiding of the rolling elements in the pocket, in particular an optimal abutment of the end surfaces of the rolling elements on the ring elements, and a low influencing or interference between rolling element and cage in the connecting region between bridge and ring element advantageously occurs. The running and guiding behavior of the bearing cage, as well as its structural integrity or load-bearing capacity can thereby also be improved.

In order to further increase the structural load-bearing capacity of the bearing cage, it is furthermore advantageous if the ratio of the minimum bridge width Sₘᵢₙ in the second connection region of the bridge to the second ring element to a maximum bridge width Sₘₐₓ in the first connection region of the bridge to the first ring element falls between 0.5 and 1 (0.5≤(Sₘᵢₙ/Sₘₐₓ)≤1), preferably between 0.8 and 0.99 (0.8≤(Sₘᵢₙ/Sₘₐₓ)≤0.99).

Alternatively or additionally the ratio between maximum ring element thickness Rₘₐₓ, in particular the ring element thickness measured in the center of the pocket, and minimum ring element thickness Rₘᵢₙ, measured at the lowest point of the recess, can also fall between 1.05 and 1.4 (1.05≤(Rₘₐₓ/Rₘᵢₙ)≤1.4). A bearing cage having at least one of the above-mentioned ratios has a particularly good structural load-bearing capacity.

Furthermore the bearing cage usually has a radial inner side and a radial outer side. Here the inventors have recognized that when the enlargement of the bridge follows a curvature having the radius r, the radius of curvature rₐ on the radially outer side can be greater than the radius of curvature rᵢ on the radially inner side, in particular when the cage is manufactured by stamping and punching. Here in particular the radius rₐ on the radially outer side is defined by using a first tool, in particular a punching tool, and the radius rᵢ on the radially inner side by using a second tool, in particular a stamping tool. In particular, a center axis of the radius of curvature rᵢ on the radially inner side and the radius of curvature rₐ on the radially outer side may not be parallel. In other words, the center axis of the radius of curvature rᵢ on the radially inner side and the radius of curvature rₐ on the radially outer side may be inclined to each other. For example, the radius of curvature rₐ on the radially outer side may be in a direction of the punching tool such as the radial direction, while the radius of curvature rᵢ on the radially inner side, which is created by the angle from the stamping tool, may be tangential on the roller bridge contact. Due to this different design of the radii on the outer side and on the inner side the structural integrity of the cage can also be further improved. Also, the feasibility of manufacturing can be improved by having different radii.

Preferably, at least one ring element has a radially extending portion and an axially extending portion which are connected by a bend portion having a radius, the recess being formed such that the recess is spaced from the bend portion. For example, if the bearing cage is made from a metal plate, the final cage contour shape may be obtained by bending the flat base material in a round shape. This may result in at least one of the ring elements having a radially extending portion and an axially extending portion which are connected by a bend portion having a radius. If the recess is located and/or designed, for example in terms of size, such that it would cut into the bend portion of the at least one ring element, this could lead to a stress concentration in that region. Thus, for a stress-optimized design it may be important to separate the recess, which may be arranged in a corner of a cage pocket, from the radius of the bend portion of the at least one ring element.

According to a further advantageous exemplary embodiment the bearing cage is manufactured from a metal plate. Here it is particularly advantageous if the metal plate has a particular metal-plate thickness, wherein the radius r of the curvature along which the bridge enlarges is dependent on the metal-plate thickness t so that the radius falls in the following defined range:

$$0.12 t \leq r \leq 2 t ,$$

wherein t represents a thickness of the metal-plate, measured in units of a dimension, and wherein r represents a radius of curvature, measured in units of a dimension. In particular, t and r may have the same unit. Please note that in case that the radius of curvature is variable r refers to the equivalent constant radius as defined above. Preferably, the radius may be between 0.25t and t (0.25t≤r≤t). This has the advantage that higher radii may be better for optimizing the structural load-bearing capacity of the bearing cage.

A further advantage of the bearing cage according to the disclosure is that due to the design described above the structural load-bearing capacity of the bearing cage can be increased such that even a reduction of the metal-plate thickness is possible. This in turn leads to a reduction of the material consumption and thus a cost reduction.

A further aspect relates to a rolling-element bearing, in particular a tapered roller bearing, including at least one inner ring, one outer ring, and roller-shaped rolling elements disposed therebetween, wherein the rolling elements are received in a bearing cage as described above.

Furthermore it is advantageous if the roller-shaped rolling elements include a running surface by which they roll on the inner and outer ring and are at least partially guided by the bridge of the bearing cage, and include a first and a second end surface, the first end surface being associated with the first ring element of the bearing cage and the second end surface being associated with the second ring element. It is particularly advantageous here if an edge reduction is provided in a transition region between first and/or second end surface and the running surface so that the first and or second end surface is offset radially inward from the running surface by an edge reduction value k, and in the transition region between running surface and first end surface or second end surface the running surface is shorter by the edge reduction value k than the total longitudinal extension of the roller between first and second end surface. The edge reduction is preferably symmetrical; however it is also possible that edge reduction values differ between running surface and end surface and/or also at the first or second end side.

Furthermore it is advantageous if the recess depth y of the recess on the bearing cage is defined by the edge reduction value k, wherein the radius of the recess curvature in the first connection region satisfies the inequality: (r−y)≤k. It can thereby be ensured that the edge reduction of the roller-shaped rolling element and the recess do not adversely affect or interfere with each other.

In addition, a ratio of edge reduction value k to the recess depth y may preferably fall in the range between 0.75 and 2.33 (0.75≤(k/y)≤2.33), even more preferably between 1.2 and 1.8 (1.2≤(k/y)≤1.8). It can thereby be ensured that the edge reduction of the roller-shaped rolling element and the recess do not adversely affect or interfere with each other.

Furthermore the inventors have found that with a continuous bridge widening in the connecting region between bridge and ring element, it is advantageous if the radius of curvature r and the edge reduction value are in a particular ratio to each other wherein the following is true of the radius r:

$$1.1 k \leq r \leq 1.4 k$$

Please note that if the radius of curvature is variable, r refers to the equivalent constant radius as defined above.

If the rolling-element bearing includes a bearing cage in which the curvature of the bridge widening in the connecting region between bridge and ring element on the outer side of the cage differs from that on the inner side of the cage, then it is also advantageous if the following is true of the radius of curvature at the outer side:

$$1.1 k \leq {r}_{a} \leq 1.4 k$$

And/or the following is true for the inner radius:

$$0.8 k \leq {r}_{i} \leq 1.1 k$$

Further preferred embodiments are defined in the dependent claims as well as in the description and the figures. Thereby, elements described or shown in combination with other elements may be present alone or in combination with other elements without departing from the scope of protection.

### BRIEF DESCRIPTION OF THE DRAWINGS

In the following, preferred embodiments of the invention are described in relation to the drawings, wherein the drawings are exemplarily only, and are not intended to limit the scope of protection. The scope of protection is defined by the accompanied claims, only.

FIG. 1 a schematic sectional view through a first exemplary embodiment of a bearing cage according to the disclosure.

FIG. 2 a schematic sectional view through the bearing cage of claim 1 that includes a roller received therein.

FIG. 3A a detailed view of a pocket of the cage of FIG. 1.

FIG. 3B a detailed view of a radius of curvature of a recess of the pocket of the cage of FIG. 1, the detail being identified as detail section 3B of FIG. 3A.

FIGS. 4A and 4B are detail views of the pocket depicted in FIG. 3A with a roller received therein.

### DETAILED DESCRIPTION OF THE INVENTION

In the following same or similar functioning elements are indicated with the same reference numerals.

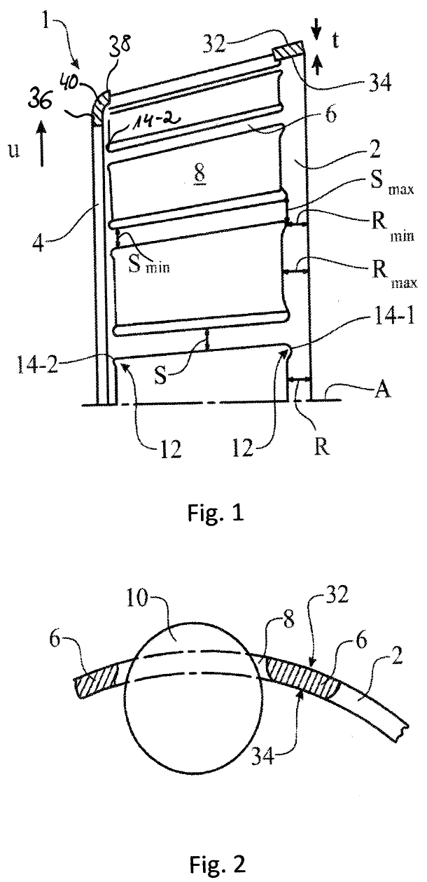

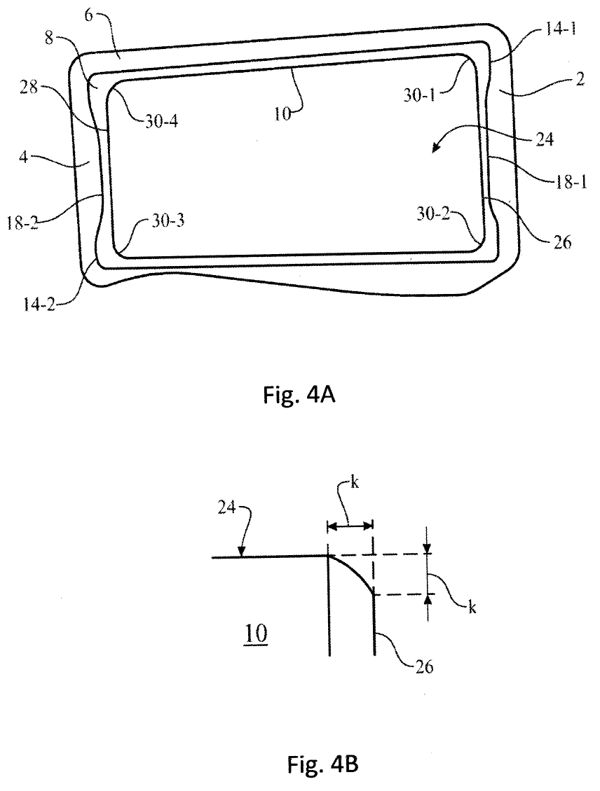

A sectional view through a bearing cage 1 of a tapered roller bearing, including a first ring element 2 and a second ring element 4 that are connected to each other by a plurality of bridges 6 is illustrated in FIG. 1. Pockets 8 are thereby formed between the first ring element 2, the second ring element 4, and the bridges 6, in which pockets roller-shaped rolling elements (shown in FIGS. 2 and 4) are receivable. The receiving of a rolling element 10 is depicted in FIG. 2, wherein in addition the ring element 2 and, in sectional view, the bridges 6 are visible. As can further be seen in FIG. 2, the rolling element 10 is received in the pocket 8. Even though a tapered roller bearing is depicted in the figures, other rolling-element bearings can be equipped with a cage that is similarly equipped in the transition region between bridge and ring.

The bearing cage itself is usually manufactured from a metal plate. When the flat base material of the bearing cage 1 is formed to the final contour shape of the cage 1, which is usually round as shown in FIG. 1, at least one of the first and second ring elements 2, 4, usually the ring element that has the smaller diameter when the cage is for tapered rollers, has a radially extending portion 36 and an axially extending portion 38 which are connected by a bend portion 40 having a radius.

Furthermore, as can be seen in the sectional view of FIG. 1 the bearing cage 1 has a metal-plate thickness t. Due to the novel design of the bearing cage 1 described below this metal-plate thickness t can be reduced without impairing the structural load-bearing capacity of the bearing cage 1.

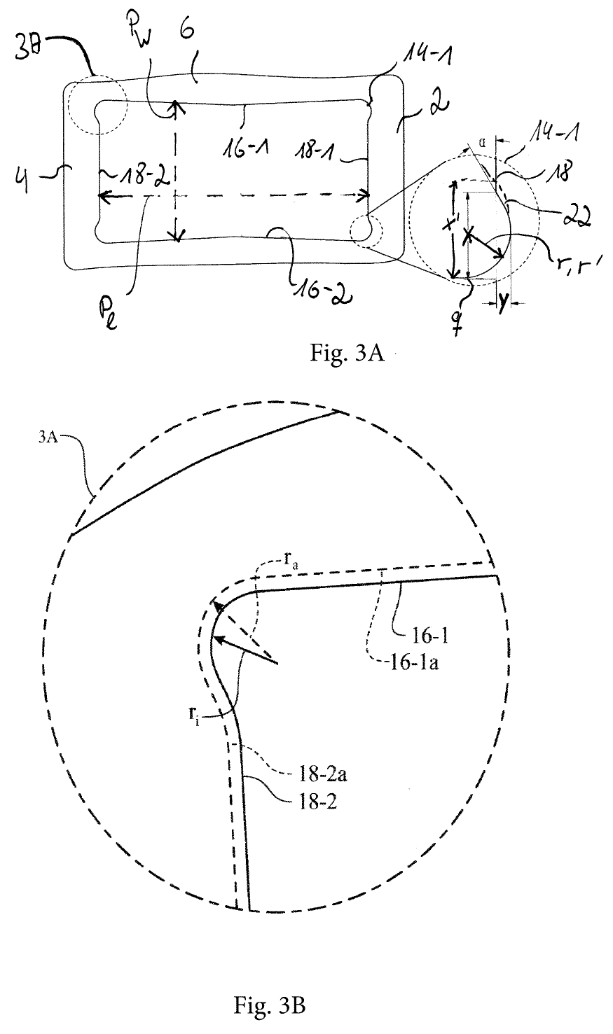

For this purpose the bearing cage 1 further includes recesses 14-1 in a connection region 12 between the bridge 6 and the first ring element 2 and a recess 14-2 in a connection region 12 between the bridge 6 and the second ring element 4. These recesses 14-1, 14-2 are configured such that in this region a reduction of the ring element thickness R is effected specifically to a minimum ring element thickness Rₘᵢₙ, but an enlargement of the bridge width S is effected specifically to a maximum bridge width Sₘₐₓ. The enlargement of the bridge width S in the first connection region is continuous and occurs along a curvature having a predetermined radius r (FIG. 3A). The predetermined radius r may be a constant radius or may vary along the curvature. In particular, the predetermined radius may be characterized by a starting point q on the bridge 6, and a resulting recess depth y in the axial direction. As can be seen from FIG. 3A, a recess having a curvature with a constant radius r (indicated by the solid line) and a recess having a curvature with a radius r′ that varies along the curvature (indicated with the dashed line) may have the same starting point q on the bridge 6 and the same recess depth y but may differ with respect to a recess length x or x′ in the circumferential direction.

Preferably, the radius of curvature r′ varies such that the radius increases towards a zone of maximum stress and decreases outside of the zone of maximum stress. For example, the radius of curvature r′ may vary continuously along the curvature. Preferably, the radius of curvature may vary non-linearly, for example exponentially, logarithmically, and/or according to an nth degree polynomial. Here, a ring element thickness in the axial direction is measured with respect to an axis of rotation A of the bearing cage 1, while a bridge width is measured in the circumferential direction U of the bearing cage.

Furthermore, the recess 14-1, 14-2 is formed such that it is spaced from the bend portion 40. If the recess is located and/or designed, for example in terms of size, such that it would cut into and/or interfere with the bend portion 40 of the ring element 2, 4, it could lead to a stress concentration in that region. Thus, for a stress-optimized design it may be important to separate the recess from the radius of the bend portion 40 of the ring element 4.

In the depicted bearing cage of a tapered roller bearing, the minimum bridge width Sₘᵢₙ is preferably measured at a second connection region at the second ring element 4, while the maximum ring element thickness Rₘₐₓ is preferably measured in the center of the pocket 8. With cages of other rolling-element bearings the values can be determined at other points.

FIG. 3A shows an example of a pocket. Only one pocket is depicted here. The bridge and ring element are depicted only in section, and each show their inner edges 18-1, 18-2 (ring element) or 16-1, 16-2 (bridges) so that no ring element thickness or bridge width is visible here. Furthermore, FIG. 3A shows in particular in the enlarged cutouts that the recess 14-1 has a certain recess length x in the circumferential direction and a recess depth y. It has further proven here that is advantageous if the ratio between recess length x and recess depth y falls in the range from 2 to 10:

$$2 \leq ( x / y ) \leq 10$$

Furthermore the enlarged cutouts show that the transition from the recess 14-1 to the inner edge of the pocket is effected such that a tangent 22 to the recess progress line is angled at an angle α with respect to the inner edge. The angle α preferably falls in the range of 10°-40°.

As can be seen in FIG. 3A, the pocket 8 has a pocket width P_{w}, and a pocket length Pₗ, wherein the pocket width P_{w} is minimal at 20 to 60% of the pocket length Pₗ. For example, in case of a tapered roller bearing, the minimal pocket width P_{w} is located at a position which is spaced 25-55% of the pocket length Pₗ from the second ring element 4. Thus, for a tapered roller bearing, the width of the bridge 6 is smallest in the connection region that connects the bridge to the smaller ring element 4 of the bearing cage 1.

Furthermore it can be seen in FIG. 3A that the transition from minimum ring element thickness Rₘᵢₙ to increased bridge width S occurs continuously and along a curvature having radius r. As mentioned above, the radius r varies along the recess.

Furthermore FIG. 4A shows an exemplary embodiment of the cage of FIG. 3A with roller 10 received therein. As can further be seen in FIGS. 4A and 4B, the roller 10 includes a running surface 24, via which the roller 10 rolls along on the inner or outer ring of the rolling-element bearing (not depicted) and is guided by the bridge 6. Furthermore the roller 10 includes a first end surface 26 that is associated with the first ring element 2 and a second end surface 28 that is associated with the second ring element 4. The end surfaces 26, 28 interact with the inner sides 18-1, 18-2 of the ring elements 2, 4, respectively. As can further be seen from FIGS. 4A and 4B, each roller 10 includes an edge reduction 30-1, 30-2, 30-3, 30-4 at the transition region between running surface 24 and the end surfaces 26, 28. One of these edge reductions 30-1 is depicted enlarged in FIG. 4B. Here the running surface or the first or second end surface is respectively reduced by an edge reduction value k. As depicted, the edge reduction is preferably symmetrical.

The edge reduction value k in turn determines the recess depth y, wherein the radius r of the recess curvature in the connection region satisfies the inequality: (r−y)≤k.

In addition, a ratio of edge reduction value k to the recess depth y preferably falls in the range between 0.75 and 2.33, 0.75≤(k/y)≤2.33, more preferably between 1.2 and 1.8, 1.2≤(k/y)≤1.8.

It can be ensured by this relationship that an optimal balance is achieved between the edge reduction k and the recess y so that no interference arises between roller 10 and cage 1. It can thereby also be ensured that a sufficiently large radius of curvature r, r′ or an enlargement of the bridge width S can be effected without the roller 10 jamming in the cage 1.

Furthermore it can be advantageous if the recess has a different radius of curvature at the radially outer surface 32 of the cage (see FIG. 1) than at the radially inner surface 34 of the cage (see FIG. 1). A radius of curvature of the recess at a location between its radially inner and radially outer ends may sometimes be referred to herein as a first radius of curvature. The radius of curvature rₐ at the outer end of the recess may sometimes be referred to as a second radius of curvature and the radius of curvature rᵢ at the inner end of the recess may be referred to as a third radius of curvature. These different radii of curvature, rᵢ, rₐ are identified in an enlarged section of FIG. 3A illustrated in FIG. 3B. However, it is advantageous if the outer radius of curvature rₐ is generally greater than the inner radius of curvature rᵢ, and the outer radius of curvature rₐ is usually provided by a first tool and the inner radius of curvature rᵢ is provided by a second tool. More specifically, the bearing cage 1 has a radially inner side 34 and a radially outer side 32, wherein a radius of curvature rₐ located on the radially outer side 32 is greater than a radius of curvature rᵢ, located on the radially inner side 34 and wherein the radius of curvature rₐ located on the radially outer side 32 is formed by an application of a punching tool and the radius of curvature rₐ located on the radially inner side 34 is formed by an application of a second stamping tool. Thus it is advantageous; for example, if the outer radius rₐ is provided by punching of a metal plate, while the inner radius rᵢ is formed by a subsequent stamping treatment of the bearing cage.

Overall, using the disclosed bearing cage design a bearing cage can be provided whose structural load capacity is increased such that it even allows to form a bearing cage for a large diameter bearing, in particular for a wind turbine, from a metal plate. In addition, interference and thus jamming of the rollers 10 in the cage pockets 8 can be reliably prevented despite increased radius of curvature r between bridge 6 and ring element 2, 4. At the same time, by adapting the recess length x and recess depth y the cage 1 can be optimally adapted to the desired properties.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved roller bearing cages.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMERAL LIST

1 Bearing cage
2 First ring element
4 Second ring element
6 Bridge
8 Pocket
10 Roller
12 Connection region
14-1 Recess
14-2 Recess
16-1, 16-2 Bridge inner edge
18-1, 18-2 Ring element inner edge
22 Transition between recess and inner edge of the ring element
24 Running surface of the roller
26, 28 End surface of the roller
30-1, 30-2, 30-3, 30-4 Edge reduction
32 Radially outer side/edge
34 Radially inner side
36 radially extending portion
38 axially extending portion
40 bend portion
α angle
r, rₐ, rᵢ, r′ Radius of curvature
k Edge reduction value
t Metal-plate thickness
S, Sₘᵢₙ, Sₘₐₓ Bridge width
R, Rₘᵢₙ, Rₘₐₓ Ring element thickness
x, x′ Recess length
q recess starting point
y Recess depth
u Circumferential direction
A Axial direction
Pw pocket width
Pl pocket length

What is claimed is:

1. A bearing cage configured for a large-diameter roller bearing and comprising:
a first ring element, and
a first bridge extending substantially axially from a first connection region of the first ring element,
wherein the first connection region includes a first recess extending into the first ring element, the first recess having a radially outer end and a radially inner end and a first radius of curvature at a location between the radially outer end and the radially inner end, the first radius of curvature being constant or variable.

2. The bearing cage according to claim 1,
wherein the first radius of curvature is constant.

3. The bearing cage according to claim 1,
wherein the first radius of curvature is variable.

4. The bearing cage according to claim 3,
wherein the first radius of curvature increases towards a zone of maximum stress and decreases outside of the zone of maximum stress.

5. The bearing cage according to claim 3,
wherein the first radius of curvature varies continuously.

6. The bearing cage according to claim 5,
wherein the first radius of curvature varies exponentially, logarithmically, and/or according to an nth degree polynomial.

7. The bearing cage according to claim 1,
including a second ring element,
wherein the first bridge is connected to the second ring element at a second connection region having a second recess, and
wherein a circumferential width of the first bridge in the second connection region is smaller than a circumferential width of the first bridge in the first connection region.

8. The bearing cage according to claim 7,
wherein a circumferential width of the first bridge in the second connection region is smaller than a circumferential width of the first bridge at a location between the first connection region and the second connection region.

9. The bearing cage according to claim 7,
including a second bridge extending between the first ring element and the second ring element, the first and second ring elements and the first and second bridges defining a pocket,
wherein a circumferential distance between the first bridge and the second bridge is a pocket width,
wherein an axial distance between the first ring element and the second ring element is a pocket length, and
wherein the pocket width is smallest at a position spaced 20% to 60% of the pocket length from the second ring element.

10. The bearing cage according to claim 9,
wherein the second ring element has a smaller diameter than a diameter of the first ring element, and
wherein the smallest pocket width is located at a position spaced 25% to 55% of the pocket length from the second ring element.

11. The bearing cage according to claim 1,
wherein the radially outer end of the first recess has a second radius of curvature and the radially inner end of the first recess has a third radius of curvature, and
wherein the first radius of curvature is greater than the second radius of curvature

12. The bearing cage according to claim 11,
wherein a center axis of the second radius of curvature is inclined relative to a center axis of the third radius of curvature.

13. The bearing cage according to claim 1,
wherein the first ring element and the first bridge are formed from sheet metal.

14. The bearing cage according to claim 1,
wherein the first ring element has a radially extending portion and an axially extending portion connected by a bend portion having a radius, and
wherein the first recess is spaced from the bend portion.

15. A roller bearing comprising:
an inner ring,
an outer ring,
a bearing cage according to claim 7 disposed between the inner ring and the outer ring, and
a plurality of roller elements mounted in the bearing cage.

16. The roller bearing according to claim 15,
wherein the roller elements have a first end surface facing the first ring element and a second end surface facing the second ring element an a running surface between the first end surface and the second end surface, the running surface being configured to roll on the inner ring and on the outer ring and to contact the first bridge,
wherein at a transition region between first end surface and the running surface the first end surface is offset radially inward by an edge reduction value so that the running surface is shorter by the edge reduction value than a total longitudinal extension of the roller element between the first end surface and the second end surface,
wherein a recess depth of the recess on the bearing cage is defined by the edge reduction value,
wherein the at least one radius of curvature in the first connection region satisfies the inequality: (r−y)≤k,
wherein r is the at least one radius of curvature, y s the recess depth, and k is the edge reduction value.
